(19) United States
(12) Patent Application Publication
(10) Pub. No.: US 2012/0000320 A1
(43) Pub. Date: Jan. 5, 2012

(54) SPINNING LUG STUD SOCKET

(76) Inventor: Brandon Cummings, Reidsville, NC (US)

(21) Appl. No.: 12/830,312

(22) Filed: Jul. 3, 2010

(51) Int. Cl. B25B 13/50; B23P 19/06

(52) U.S. Cl. 81/53.2; 29/426.4

(57) ABSTRACT

A tool for removing a damaged lug stud from a vehicle may include, at one end thereof, a socket that fits over a lug nut. The socket may be held in place with a wrench, pliers, or the like while the stud is drilled through a bushing on the other end of the tool. The tool may remove the damaged lug stud quickly, without damage to the wheel of the vehicle.

### BACKGROUND OF THE INVENTION

The present invention relates to the field of hand and power tools and, more particularly, to apparatus and methods for removing damaged lug studs.

On many modern vehicles, such as automobiles, lug studs are pressed into a hub flange. When a lug stud on a vehicle becomes damaged, it may become difficult to remove. For example, at times, lug studs may break loose from the flange and spin while trying to remove the lug nut. This makes it very difficult to remove the wheel without damaging it, taking up to several hours to perform this task.

As can be seen, there is a need for an apparatus and method for removing lug studs from a vehicle without damaging the vehicle wheel.

### SUMMARY OF THE INVENTION

In one aspect of the present invention, a tool comprises a cylindrical member having a first end and a second end; an interior shape of the first end adapted to fit over and secure a nut; an exterior shape of at least a portion of the cylindrical member being flat, the flat portion adapted to permit securing the cylindrical member with a gripping tool; and a bushing within the second end of the cylindrical member.

In another aspect of the present invention, a method for removing a wheel from a damaged lug stud comprises preventing rotation of the damaged lug stud; drilling a central portion of the lug stud a first time with a first drill bit to a depth at least as deep as a height of a lug nut on the damaged lug stud; drilling the central portion of the lug stud a second time with a second drill bit to about the same depth as the first time, the drilling being at a diameter approximately equal to a diameter of the damaged lug stud; and removing the lug nut from the damaged lug stud.

These and other features, aspects and advantages of the present invention will become better understood with reference to the following drawings, description and claims.

### BRIEF DESCRIPTION OF THE DRAWINGS

FIG. 1 is a bottom view of a tool according to an embodiment of the present invention;

FIG. 2 is a side view of the tool of FIG. 1;

FIG. 3 is a perspective view of the tool of FIG. 1;

FIG. 4 shows a simplified cross-sectional view of a wheel having a damaged lug stud; and

FIGS. 5A through 5C show a pictorial flow chart describing the use of the tool of FIG. 1, according to an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a tool for removing a damaged lug stud from a vehicle. One end of the tool may include a socket that fits over a lug nut. The socket may be held in place with a wrench, pliers, or the like while the stud is drilled through a bushing on the other end of the tool. The tool may remove the damaged lug stud quickly, without damage to the wheel of the vehicle.

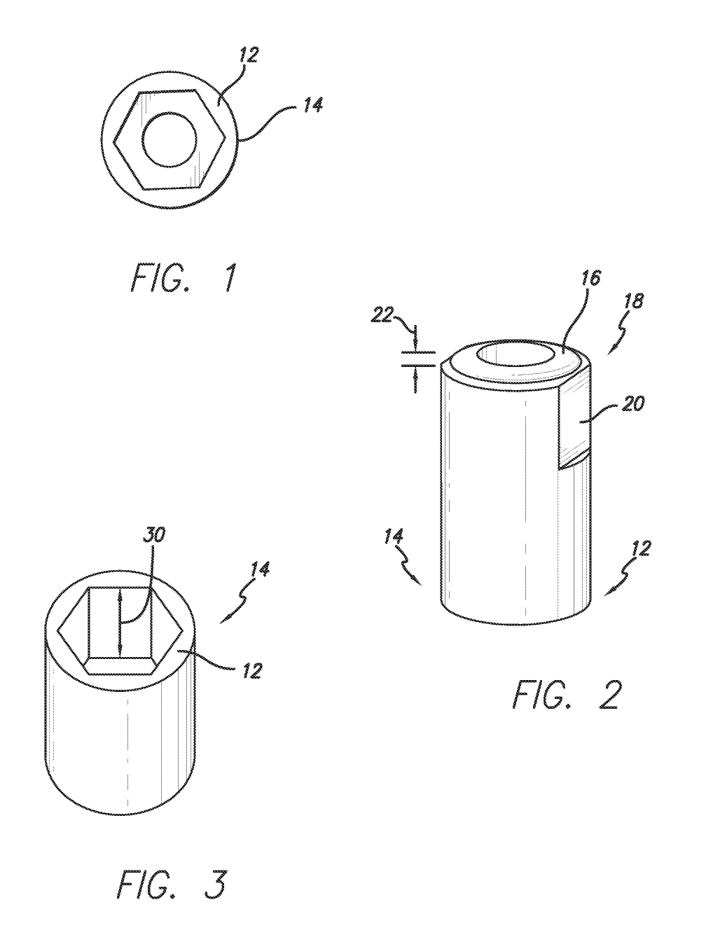

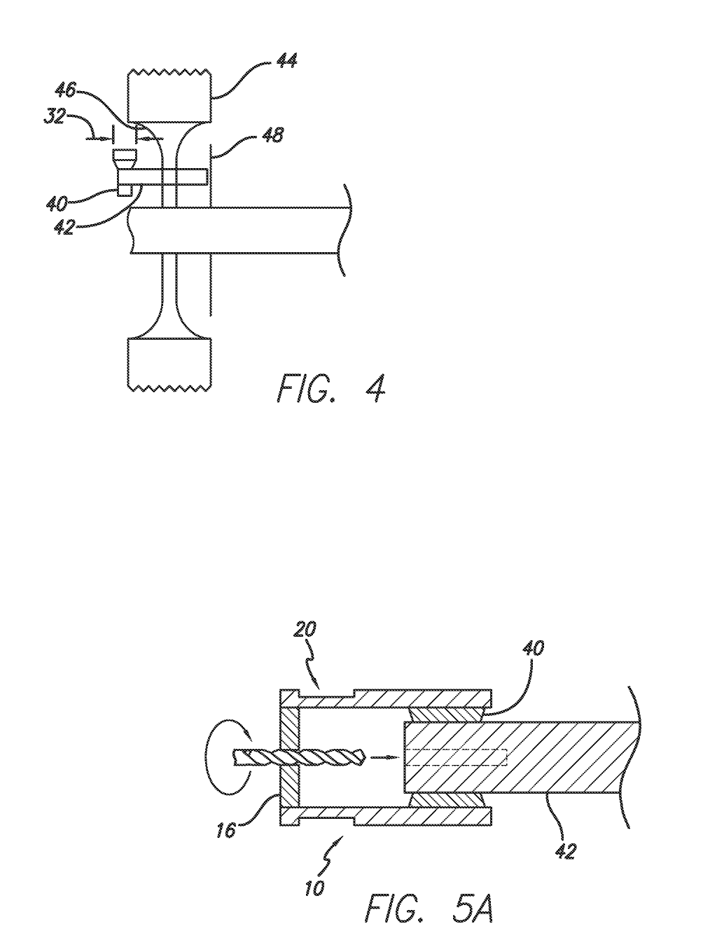

Referring to FIGS. 1 through 4, a tool 10 may be a cylindrical member having a socket 12 at a first end 14 and a bushing 16 at a second end 18 thereof. The socket 12 may be formed as a conventional socket, for example, as a 6-point socket, a 12-point socket or the like. The size of the socket 12 (e.g., inside diameter) may be standard socket sizes, including SAE and metric sizes. The size of the socket 12 may be selected to fit onto a lug nut 40 of a vehicle (not shown).

The tool 10 may include wrench flats 20 located, for example, on opposite sides of the tool 10. In an alternate embodiment, multiple sets of wrench flats 20, for example three sets of two opposite wrench flats, may be disposed around a portion of the exterior of the tool 10. The wrench flats 20 may be located at or near the second end 18 of the tool 10. In one embodiment, the wrench flats 20 may be located at the second end 18. In an alternate embodiment, the wrench flats may be located a distance 22 from the second the 18. This distance 22 may help secure a wrench, for example, onto opposite wrench flats 20, without the wrench sliding off the second end 18.

The socket 12 and wrench flats 20 may be integrally formed from steel, typically hardened steel, however other materials may be used. The bushing 16 may be insertable into an opening in the second end 18 of the tool 10. In one embodiment, the opening in the second end 18 may be circular wherein the busing 16 may have a circular outside diameter. The outside diameter of the bushing 16 may be installed in the second end 18 with a friction fit or may be secured within the second end 18 by, for example, welding or a locking ball/socket mechanism similar to a typical socket/rachet connection. In an alternate embodiment, the bushing 16 may be formed integrally with the rest of the tool 10, resulting in a single solid tool. The bushing 16 may be formed from, for example, hardened steel.

The bushing 16 may have an inside diameter sized for passing a drill bit therethrough during use of the tool 10, as discussed below. Various sized bushings may be supplied with various socket sizes so that different drill bit sized may be used to help drill out a lug stud 42.

The socket 12 of the tool 10 may have a depth 30 smaller, equal to or greater than a height 32 of the lug nut 40. In one embodiment, the depth 30 of the socket 12 may be less than the height 32 of the lug nut 40. This configuration may prevent the first end 14 of the tool 10 from contacting the wheel 46 when the tool 10 is placed over the lug nut 42.

To use the tool 10, for example, a ¾ inch socket may be used for a ½ inch lug stud 42. The socket may fit over and hold the nut 40 while the wrench flats on the tool may help hold the tool 10 in place. Typically, a starter hole, significantly smaller than the lug stud diameter (for example, about 50% or less than the diameter of the lug stud), may be drilled into the lug stud 42. To do so, a user may select a tool having a ¾ inch socket with a bushing having an inside diameter of, for example, about ⅛ inch. The user would then use a ⅛ inch drill bit, for example, a conventional high speed steel drill bit, to drill the lug stud after inserting the drill bit thought the bushing of the tool. Other sizes may be used for drilling the starter hole. Typically, the second hole drilled into the lug stud 42 would be about the same size as the lug stud itself. In this case, a bushing having an inside diameter of ½ inch would be used with a ½ inch drill bit. Depending on the size of the lug stud, intermediate holes may be drilled into the lug stud by using bushings having intermediate sized inside diameters with the corresponding drill bits.

Once this ½ inch hole is drilled, the lug nut 40 should easily break away from the remainder of the lug stud. Each hole should be drilled to a depth of at least the height of the lug nut 40. This may allow the tire 44 to be removed from the vehicle (not shown) without damage to the wheel 46. A new lug stud may then be press fitted into the hub flange 48.

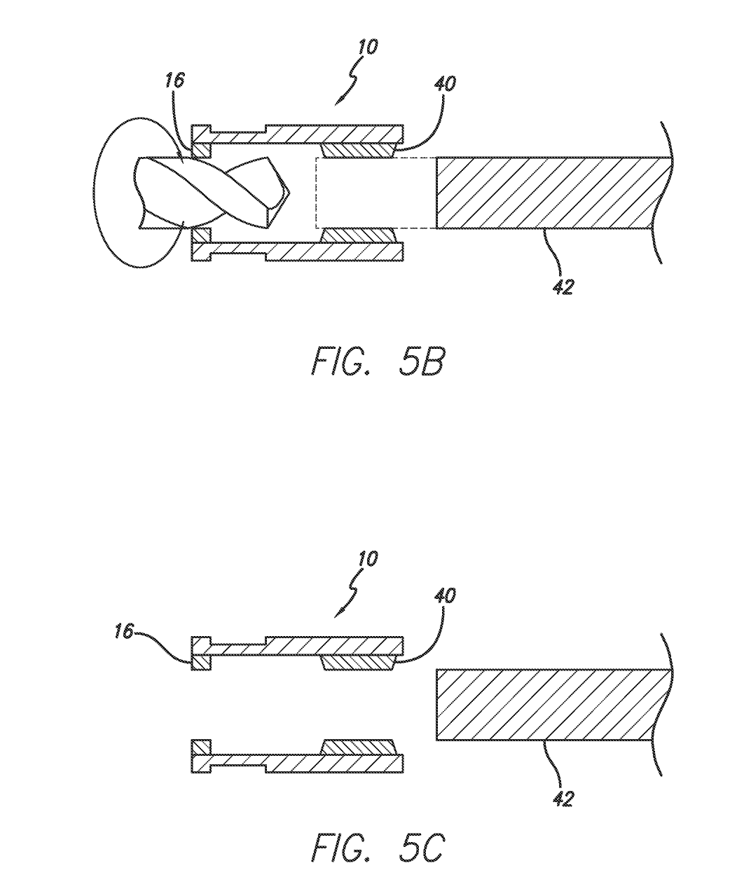

FIGS. 5A through 5C show a pictorial description of the above described process.

It should be understood, of course, that the foregoing relates to exemplary embodiments of the invention and that modifications may be made without departing from the spirit and scope of the invention as set forth in the following claims.

What is claimed is:

1. A tool comprising:
a cylindrical member having a first end and a second end;
an interior shape of the first end adapted to fit over and secure a nut;
an exterior shape of at least a portion of the cylindrical member being flat, the flat portion adapted to permit securing the cylindrical member with a gripping tool; and
a bushing within the second end of the cylindrical member.

2. The tool of claim 1, wherein the exterior shape includes wrench flats.

3. The tool of claim 1, wherein the first end is a socket.

4. The tool of claim 1, wherein the bushing is removable from the cylindrical member.

5. The tool of claim 1, wherein the bushing is integral to the cylindrical member.

6. The tool of claim 1, wherein a depth of the interior shape is less than a height of the nut.

7. The tool of claim 1, wherein the nut is a lug nut on a damaged lug stud.

8. A method for removing a wheel from a damaged lug stud, the method comprising:
preventing rotation of the damaged lug stud;
drilling a central portion of the lug stud a first time with a first drill bit to a depth at least as deep as a height of a lug nut on the damaged lug stud;
drilling the central portion of the lug stud a second time with a second drill bit to about the same depth as the first time, the drilling being at a diameter approximately equal to a diameter of the damaged lug stud; and
removing the lug nut from the damaged lug stud.

10. The method of claim 9, wherein the step of preventing rotation of the damaged lug stud in performed using a tool, the tool having:
a cylindrical member having a first end and a second end;
an interior shape of the first end adapted to fit over and secure the lug nut;
an exterior shape of at least a portion of the cylindrical member being flat, the flat portion adapted to permit securing the cylindrical member with a gripping tool; and
a bushing within the second end of the cylindrical member.

11. The method of claim 9, wherein the first time includes drilling the lug stud with a drill bit having a diameter less than about 50% of the diameter of the lug stud.

12. The method of claim 10, further comprising securing the tool by gripping wrench flats of the tool with the gripping tool.

13. The method of claim 10, wherein, for the first time, the bushing of the tool has a first inside diameter about the same size as the first drill bit.

14. The method of claim 13, wherein, for the second time, the bushing of the tool has a second inside diameter about the same size as the second drill bit.

15. The method of claim 14, further comprising changing from the first inside diameter to the second inside diameter by changing from a first bushing in the tool to a second bushing in the tool.

16. The method of claim 14, further comprising changing from the first inside diameter to the second inside diameter by changing from a first tool to a second tool, the first tool having a first bushing with the first inside diameter and the second tool having a second bushing with the second inside diameter.

17. The method of claim 10, further comprising drilling the central portion of the lug stud an intermediate time with an intermediate drill bit, having a diameter between the diameter of the first drill bit and the second drill bit, to about the same depth as the first time.
